(19) United States
(12) Patent Application Publication
(10) Pub. No.: US 2011/0192487 A1
(43) Pub. Date: Aug. 11, 2011

(54) Polyethylene Pipes

(75) Inventors: Johan De Clippeleir, Oud Heverlee (BE); Heinz Vogt, Frankfurt (DE); Gulnaz Idiyatullina, Konigsstein i. T. (DE)

(73) Assignee: BASELL POLYOLEFINE GMBH, Wesseling (DE)

(21) Appl. No.: 13/061,304

(22) PCT Filed: Sep. 3, 2009
(86) PCT No.: PCT/EP2009/006392

§ 371 Date: Apr. 8, 2011

(30) Foreign Application Priority Data
Sep. 8, 2008 (EP) 08015796.9

(51) Int. Cl. F16L 9/00; B29C 47/20

(52) U.S. Cl. 138/177; 264/209.1

(57) ABSTRACT

A new polymeric composition of extruded conduits and pipes is described, which is free of fluoroelastomer processing additive whilst maintaining superior processability.

This application is the U.S. national phase of International Application PCT/EP2009/006392, filed Sep. 3, 2009, claiming priority to European Application 08015796.9 filed Sep. 8, 2008; the disclosures of International Application PCT/EP2009/006392 and European Application 08015796.9, each as filed, are incorporated herein by reference.

The present invention relates to the field of manufacturing pipes and other conduits made from polyethylene comprising polybutene-1 and being substantially free of fluoroelastomer. Further it relates to the conduits manufactured in such way.

Use of fluoroelastomer processing additives is widespread in extrusion-borne processes. They act as specific lubricants, allowing of high throughput rates without suffering from melt fracture phenomena, which either lead to irregular spots of surface roughnesses, diminished wall thickness or, with thinly walled objects in particular, even to leaky walls. They are conventionally known in the art as polymer processing aids (PPA) and are commercially available, for example, under the trade names Viton® and Dynamar® (cf. also, for example, U.S. Pat. No. 3,125,547);

Piping equipment in particular, is vulnerable to any kind of irregularity of wall integrity, in view of pressure and stress-crack resistance. However advantageous being in terms of processing, use of fluoroelastomer additives suffers from some disadvantages especially for applications in regulated, health-related industries such as the water treatment, food or medical industries; fluoroelastomers are believed to be noxious to human health and may exudate and migrate from the plastic material to any fluid carried along within the piping itself. Further, interference with other polyolefine additives was observed. Certain polyolefin additive classes such as pigments or other have been known to negatively interfer with the fluorocarbon-elastomer processing additive in the same polymer (Rudin et al., 1985, J. Plast. Film Sheet I (3): 189, Fluorocarbon Elastomer Processing Aid in Film Extrusion of LLDPEs; B. Johnson and J. Kunde, SPE ANTEC 88 Conference Proceedings XXXIV: 1425 (1988), The Influence of Polyolefin Additives on the Performance of Fluorocarbon Elastomer Process Aids).

It is an object of the present invention to avoid the disadvantage of the prior art and to devise a polyethylene conduit material and conduits manufactured thereof that show good processing properties in the absence of said fluoroelastomer additives. This problem is surprisingly solved by the inclusion of only minor amounts of polybutene-1. This substitution of fluoroelastomers by polybutene-1, for extrusion based manufacturing of conduits, has not been known before.

According to the present invention, a conduit or pipe is devised which is comprising of from 95 to 99.999% of a polyethylene and of from 0.001 to 5% of a polybutene-1 by weight of the total polymer. Preferably, the polybutene-1 is present in an amount from greater than 0.001% to less than 0.5% by total weight of the polymer. More preferably, the polybutene-1 is present in an amount from greater than 0.005% to less than 0.25% by total weight.

The density of the polyethylene of the composition of the invention is preferably in the medium and high density range, namely from 0.93 to 0.985 g/cm3, more preferably from 0.945 to 0.975 g/cm3, still more preferably, from 0.950 to 0.965 g/cm3, and most preferably, from 0.955 to 0.965 g/cm3. Preferably, the melt flow rate of the polyethylene MI190/5 at 190° C. and 5 kg according to ISO 1133:2005 is of from 0.1 to 10 dg/min.

It may be homopolymeric or copolymeric polyethylene or a mixture of such different polyethylenes. A copolymer of ethylene and α-olefines as comonomer, which α-olefines preferably are C3-C20, more preferably C4-C12-α-olefines and may be mono- or multiply unsaturated, e.g. a 1-alkene or 1-alkadiene, preferably are monounsaturated α-olefines, comprises at least one comonomer in addition to ethylene, preferably it comprises one or two comonomers. An example is a tertiary copolymer or terpolymer, for short, made up by polymerization of ethylene with 1-butene and 1-octene or 1-hexene. A copolymer according to the present invention may comprise preferably of from 0.2% up to 14% by weight of total comonomer.

The polybutene-1 preferably has a melt flow rate MI(190/2) according to ISO 1133:2005 at 190° C./2.16 kg of from 100 to 500 dg/min.

Preferably, the polybutene is a homopolymeric 1-polybutene.According to a preferred embodiment of the invention, the homopolymer 1-polybutene has a MI(190/2) of from 100 to 300 dg/min, most preferably of form 150 to 250 dg/min. Preferably, the homopolymer has not been visbroken. It preferably has a monomodal molecular weight distribution with a poly dispersity of preferably of from 1-5. Preferably, the homopolymer 1-polybutene is a linear homopolymer that is semicrystalline and substantially isotactic (having preferably an isotacticity of from 96-99% measured as quantity by weight of xylene-soluble matter at 0° C.). Preferably the polybutene-1 homopolymer used in the present invention has a melting point of from 81 to 109° C., corresponding to the kinetically favoured crystalline form 2. Preferably, the 1-polybutene, in particular the homopolymer 1-polybutene as defined above, does not exudate from the polyethylene composition of the present invention that is the finished conduits produced therefrom.

According to another preferred embodiment, the 1-polybutene is a copolymer with a C2-C12 olefin. The 1-polybutene is preferably a copolymer of butene comprising at least one comonomer selected from the group comprising ethylene, propylene, 1-pentene, 1-hexene, 4-methyl-1-pentene, 1-heptene, 1-octene and 1-decene and combinations thereof. Preferably, the 1-polybutene copolymer comprises 1 to 15% by weight of at least one comonomer, preferably selected from the above-mentioned group. Polybutene-1 polymers are well known in the art; they are generally polymerized by Ziegler-Natta catalyst systems in the presence of butene-1 and, if needed, comonomer. Commercial grades compliant with the above made definitions may be readily used in the present invention.

Likewise, commercial polyethylene grades may be readily used in the present invention where suitable for pipe extrusion processes. Typically, nowadays bi- or higher modal polyethylene grades are used in pipe extrusion process, for ensuring good impact and stress resistance of the conduits or pipes thus manufactured. Preferably, such polyethylene has a molecular weight distribution (MWD) of >3.5, more preferably they have an MWD of from 4-20. According to a preferred embodiment, such pipe grades of polyethylene are manufactured by at least one Ziegler-Natta- and/or Phillips catalyst. Ziegler catalysts are particularly well suited to produce substantially linear polyethylenes over a wide density range, giving rise to very inhomogenous, broadly distributed product both in terms of molecular weight as well as comonomer distribution. A Ziegler product comprises typically an essentially homopolymeric, high density part, which preferably is comprised by those mass fractions of the Ziegler product having an individual molecular weight per polymer chain of >500 000 g/mol. A Ziegler product will normally not have multiple, distinct peak fractions in molecular weight distribution.

A bi-, tri- or higher modal molecular mass distribution according to the present invention has two, three or more distinct, individual distribution peaks or maxima in molecular weight distribution. The expression of “modality of polymer” refers to the form of its molecular weight distribution (MWD) curve, i.e. the appearance of the graph of the polymer weight fraction as a function of its molecular weight. If the polymer is produced in a sequential process e.g. by utilizing reactors coupled in series and using different conditions in each reactor such as dosing of chain termination reagents and dosing of comonomer, the different polymer fractions produced in the different reactions will each have their own molecular weight distribution and viscosity. At each reactor stage, either a polyethylene homo- or copolymer is newly polymerized, depending on feeding comonomer such reactor. Of course, a cascaded reactor process may in principle also be simulated in a stepwise batch process, by changing the feed of comonomer and of molar mass regulators such as hydrogen over time. WO2007/022908 is an example of a sequential reactor process for polyethylene synthesis employing multiple Ziegler catalyst, for use in extrusion based manufacturing of piping. The molecular weight distribution curve of the resulting final, multimodal polymer can be looked at as the superposition of the molecular weight distribution curves of the polymer fractions which will according to the present invention not only be distinctively broadened compared with the curves for the individual fractions but will accordingly show two, three or more distinct, separate maxima. Multimodal polymers can be produced according to several processes, beside the afore cited example of a cascaded, multi-reactor process, likewise mixed catalyst systems can be employed for producing in-situ blends of such each individual catalyst type. For instance, it may be feasible to employ mixtures of a Ziegler and a metallocene or other kind of transition metal complex catalyst, to the extent such catalyst are compatible with each other. In case of any incompatibility, again a multi-stage, cascaded process with different catalysts employed at every reactor stage may be employed instead. Most preferably, the polyethylene is a trimodal polyethylene that has at least been partly been obtained by catalysis with a Ziegler catalyst, preferably by a cascaded reactor process providing for excellent blending of the products of each reactor step.

Preferably, the conduit according to the invention is characterised in that the polyethylene is manufactured in a reactor cascade comprising three reactor steps, and comprises, in the order of ascending weight average molecular weight Mw, 45 to 55% by weight of a first ethylen-homopolymer A, 20 to 40% by weight of a second ethylene-copolymer B with a C4-C8 Olefin and 15 to 30% by weight of a third ethylene-copolymer C, based on the total weight of the polyethylene, and wherein Mw(A)<Mw(B)<Mw(C) .

Preferably, copolymers B and C comprise C4-C8 olefin monomer units in an amount of from 1 to 8% by total weight of the respective copolymers B and C.

The determination of the molar mass distributions and the means Mn, Mw and Mw/Mn derived there from was carried out by high-temperature gel permeation chromatography using a method described in DIN 55672-1:1995-02 issue February 1995. The deviations according to the mentioned DIN standard are as follows: Solvent 1,2,4-trichlorobenzene (TCB), temperature of apparatus and solutions 135° C. and as concentration detector a PolymerChar (Valencia, Paterna 46980, Spain) IR-4 infrared detector, suited for use with TCB.

A WATERS Alliance 2000 equipped with the following precolumn SHODEX UT-G and separation columns SHODEX UT 806 M (3×) and SHODEX UT 807 connected in series was used. The solvent was vacuum destilled under Nitrogen and was stabilized with 0.025% by weight of 2,6-di-tert-butyl-4-methylphenol. The flowrate used was 1 ml/min, the injection was 500μl and polymer concentration was in the range of 0.01%<conc.<0.05% w/w. The molecular weight calibration was established by using monodisperse polystyrene (PS) standards from Polymer Laboratories (now Varian, Inc., Essex Road, Church Stretton, Shropshire, SY6 6AX, UK) in the range from 580 g/mol up to 11600000 g/mol and additionally Hexadecane. The calibration curve was then adapted to Polyethylene (PE) by means of the Universal Calibration method (Benoit H., Rempp P. and Grubisic Z., & in J. Polymer Sci., Phys. Ed., 5, 753(1967)). The Mark-Houwing parameters used herefore were for PS: kPS=0.000121 dl/g, αPS=0.706 and for PE kPE=0.000406 dl/g, αPE=0.725, valid in TCB at 135° C. Data recording, calibration and calculation was carried out using NTGPC_Control_V6.02.03 and NTGPC_V6.4.24 (hs GmbH, Hauptstraβe 36, D-55437 Ober-Hilbersheim) respectively.

Preferably, the polyethylene component of the conduit of the present invention has a viscosity number VZtotal determined acc. to ISO/R 1191 in decalin at a temperature of 135° C., of from 200 to 600 cm³/g, preferably of from 250 to 550 cm³/g, more preferably of from 350 to 500 cm³/g.

Preferably, Conduit according to claim 8 or 10, characterised in that the viscosity number VZ1 of the homopolymer A is from 50 to 120 cm3/g, and VZ2 of the mixture of the homopolmer A and the copolymer B is of from 200 to 400 cm³/g, and VZtotal of the polyethylene comprising components A,B and C is from 200 bis 600 cm³/g,measured in decalin according to ISO/R1191 at a temperature of 135 ° C.

Preferably, the conduit according to the invention is characterised in that the viscosity number VZ1 of the homopolymer A is from 50 to 120 cm3/g, and VZ2 of the mixture of the homopolmer A and the copolymer B is from 200 to 400 cm³/g, and VZtotal of the polyethylene comprising components A,B and C is from 200 to 600 cm³/g, measured in decalin according to ISO/R1191 at a temperature of 135 ° C.

### EXAMPLES

The polybuten-1 employed is homopolymeric PB0800M commercially available by Basell Polyolefine GmbH, Wesseling/Germany, and having a MI(190/2) of 200 g/10 min. The polyethylene used is a Hostalen® trimodal polyethylene grade (density 0.96 g/cm3, MI(190/5)=0.24 g/10 min.), commercially available through Basell Polyolefine GmbH, Wesseling/Germany; its synthesis in a cascaded reactor process has essentially been described in WO2007/022908.

The fluoroelastomer additive used in one of the comparative examples was VITON® Z100 (Dupont, Wilmington/USA).

The conduits were produced on a conventional Pipe extrusion machine from “Battenfeld”, Type BEX-1-45-30 B (from Battenfeld GmbH, Meinerzhagen/Germany). Hostalen CRP 100 powder was dry blended either with 0.1 weight % or 0.01 weight % of the PB-1 powder. Beside the PB-1 powder, Ca-stearate (as a chlorine scavenger) and a primary antioxidant (phenol) and a secondary antioxidant (phosphate) were added. Finally, minor amounts of Zn-stearate were present in the blend.

The attached tables exemplifies the advantage of PB-1 in contrast to (Comp. ex. 1) non-modified Hostalen CRP 100 and (comp. ex. 2) Hostalen CRP 100 blended with 0.01% by weight conventional fluoroelastomer processing aid VITON® Z100. PB-1 was added in two very different amounts, namely 0.01% and 0.1% by total weight of the blend respectively. In both instances, clear improvement both over the comparative examples 1 AND 2 was achieved.

These examples illustrate the general benefit of adding PB-1 to polyethylene for extrudating conduits therefrom: Beyond achieving full and even superior substitution of the formerly used fluoroelastomer additives, further the invention in general achieves also:
Comparable or even slightly higher specific throughput by adding PB-1, as compared to fluoroelastomer
Lower screw speed to get the same throughput
Lower melt temperature
Smooth pipe surface
No die deposits

| | Temp of | | | | | [symbol] | Temperature | | | | | Actual | |
|---|---|---|---|---|---|---|---|---|---|---|---|---|---|
| | grooved | screw | | | Through- | through- | settings | | | | | temperatures | |
| Sample | feed | speed | Torque | Power | put | put | barrel 1 | barrel 2 | barrel 3 | barrel 4 | Tool | barrel 1 | barrel 2 |
| description | [° C.] | [rpm] | [%] | [kW[ | [kg/h] | [kg/h] | [° C.] | [° C.] | [° C.] | [° C.] | [° C.] | [° C.] | [° C.] |
| HS C/100 + | 100 | 109 | 73 | 33 | 199.7 | 1.83 | 200 | 200 | 200 | 200 | 210 | 198 | 200 |
| 0.01% | | | | | | | | | | | | | |
| Fluorine | | | | | | | | | | | | | |
| elastomer | | | | | | | | | | | | | |
| HS C/100 | 100 | 124 | 71 | 37 | 200 | 1.61 | 200 | 200 | 200 | 200 | 210 | 200 | 201 |
| without | | | | | | | | | | | | | |
| processing | | | | | | | | | | | | | |
| aid | | | | | | | | | | | | | |
| HS C/100 + | 98 | 103.9 | 74 | 32 | 192.4 | 1.85 | 200 | 200 | 200 | 200 | 210 | 198 | 200 |
| 0.1% | | | | | | | | | | | | | |
| PB-1 | | | | | | | | | | | | | |
| HS C/100 + | 99 | 103.9 | 73 | 32 | 191.2 | 1.84 | 200 | 200 | 200 | 200 | 210 | 196 | 200 |
| 0.01% | | | | | | | | | | | | | |
| PB-1 | | | | | | | | | | | | | |

| | Actual | | | melt | melt | melt | | | wall | |
|---|---|---|---|---|---|---|---|---|---|---|
| | temperatures | | | temp | temp | temp | melt | line | thickness | Pipe |
| Sample | barrel 3 | barrel 4 | Tool | 1 | 2 | 3 | pressure | speed | min-max | diameter |
| description | [° C.] | [° C.] | [° C.] | [° C.] | [° C.] | [° C.] | [ bar] | [m/min] | [mm] | [mm] |
| HS C/100 + | 200 | 200 | 210 | 190 | 189 | 206 | 146 | 1 | 10.3-10.6 | 110 |
| 0.01% | | | | | | | | | | |
| Fluorine | | | | | | | | | | |
| elastomer | | | | | | | | | | |
| HS C/100 | 200 | 199 | 210 | 194 | 192 | 215 | 138 | 1.1 | 10.2-10.5 | 110.2 |
| without | | | | | | | | | | |
| processing | | | | | | | | | | |
| aid | | | | | | | | | | |
| HS C/100 + | 200 | 200 | 210 | 190 | 189 | 207 | 148 | 1 | 10.4-10.8 | 110.3 |
| 0.1% | | | | | | | | | | |
| PB-1 | | | | | | | | | | |
| HS C/100 + | 201 | 200 | 210 | 191 | 189 | 207 | 146 | 1 | 10.4-10.6 | 110.2 |
| 0.01% | | | | | | | | | | |
| PB-1 | | | | | | | | | | |

HS = Hostalen ® [symbol]
indicates data missing or illegible when filed

1. A conduit comprising from 95 to 99.999% of a polyethylene and from 0.001 to 5% of a polybutene-1 by weight of the total polymer.

2. The conduit according to claim 1, wherein the conduit is obtained by an extrusion process and is substantially free from fluoroelastomer processing additive.

3. The conduit according to claim 1, wherein the polyethylene is a homopolymer or is a copolymer of ethylene with an α-olefine or is a mixture thereof

4. The conduit according to tclaim 1, wherein the polyethylene is a multimodal polyethylene.

5. The conduit according to claim 4, wherein the polyethylene is a bi- or trimodal polyethylene.

6. The conduit according to claim 1 wherein the polybutene-1 is a polybutene-1 homopolymer.

7. The conduit according to claim 1 comprising polybutene-1 in an amount from greater than 0.001% to less than 0.5% by weight of the total polymer.

8. The conduit according to claim 1, wherein the polyethylene is manufactured in a reactor cascade comprising three reactor steps, and further comprises, in the order of ascending weight average molecular weight Mw, 45 to 55% by weight of a first ethylen-homopolymer A, 20 to 40% by weight of a second ethylene-copolymers B with a C4-C8 Olefin and 15 to 30% by weight of a third ethylen-copolymer C, based on the total weight of the polyethylene, and wherein Mw(A)<Mw(B)<Mw(C) .

9. The conduit according to claim 1, wherein the polyethylene has a density from 0.955 to 0.965 g/cm³ at 23° C.

10. The conduit according to claim 8, wherein the Copolymers B and C comprise C4-C8 olefin monomer units in an amount of from 1 to 8% by total weight of the respective copolymer B and C, respectively.

11. The conduit according to claim 1 further comprising a melt flow rate of the polyethylene MI190/5 at 190° C. and 5 kg according to ISO 1133:2005 is from 10.1 to 10 dg/min.

12. The conduit according to claim 8, further comprising a viscosity number VZ1 of the homopolymer A from 50 to 120 cm3/g, VZ2 of the mixture of the homopolmer A and the copolymer B from 200 to 400 cm³/g, and VZtotal of the polyethylene comprising components A, B and C from 200 to 600 cm³/g,measured in decalin according to ISO/R1191 at a temperature of 135° C.

13. The conduit according to claim 1, wherein it is substantially free from fluoroelastomer polymer processing additives.

14. A method of manufacturing a pipe or conduit according to claim 1, characterised in that the conduit is extrudedthe process comprising extruding the pipe or conduit substantially in the absence of fluoroelastomer processing additives.

15. A moulding composition suitable for extrusion manufacturing of conduits comprising ef-from 95 to 99.999% of a polyethylene and from 0.001 to 5% of a polybutene-1 by total weight of the composition.

16. The conduit according to claim 5, wherein the polyethylene is a trimodal polyethylene.

17. The conduit according to claim 7 comprising polybutene-1 in an amount from greater than 0.005% to less than 0.25% by weight of the total polymer.
